(19) United States
(12) Patent Application Publication
(10) Pub. No.: US 2016/0259889 A1
(43) Pub. Date: Sep. 8, 2016

(54) VISUAL DATABASE FOR MANAGING MEDICAL IMAGES AND METHODS OF USE

(71) Applicant: Lifespeed, Inc., Irvine, CA (US)

(72) Inventors: Nolan James Murtha, Los Angeles, CA (US); Matthew Allen Good, Aliso Viejo, CA (US); Chad Jason Thomas, Ladera Ranch, CA (US)

(21) Appl. No.: 15/051,543

(22) Filed: Feb. 23, 2016

Related U.S. Application Data
(60) Provisional application No. 62/127,182, filed on Mar. 2, 2015.

(51) Int. Cl. G06F 19/00; G06T 11/60; G06T 11/20; G06T 13/40; G06F 3/0484; G06F 3/0482

(52) U.S. Cl. CPC G06F 19/321; G06F 19/3418; G06F 19/3487; G06F 19/328; G06F 3/04842; G06F 3/0482; G06F 3/04845; G06T 11/206; G06T 13/40; G06T 11/60

(57) ABSTRACT

The application discloses methods, apparatus, and computer programs for providing a visual database for managing medical images, the toolsets for working with the visual database, and a telemedicine system for enabling anonymous distribution of medical images for diagnostic purposes are disclosed below.

### CROSS-REFERENCE TO RELATED APPLICATIONS

This application claims the benefit of U.S. Provisional Patent Application No. 62/127,182, entitled “VISUAL DATABASE FOR MANAGING MEDICAL IMAGES AND METHODS OF USE,” filed Mar. 2, 2015, which is incorporated by reference herein in its entirety.

### BACKGROUND

Service providers and device manufacturers are continually challenged to deliver value and convenience to consumers by, for example, providing a platform that allows a consumer to simply and safely archive their individual medical images.

### SOME EXAMPLE EMBODIMENTS

Therefore, there is a need for an approach for providing a visual database for managing medical images, toolsets for working with the visual database and a telemedicine system for enabling anonymous distribution of medical images for diagnostic purposes.

According to one embodiment, systems and methods comprise an intuitive user interface to store medical images in a visual directory for all ages and levels of technical sophistication. According to one embodiment, the structure of the directory and image database is based on a skeletal model similar to that used in modern animation, and the directory is provided in a sophisticated graphic user interface, or GUI, as a navigable human avatar. The avatar can be skeletal, based on an image of a user, or can be customized. The user can archive data and view the data in a 2D or 3D immersive display.

According to another embodiment, the systems described herein include a visual database toolsets system for storing medical data as individual components that are assembled as a user requests data. In some embodiments, the system allows a user to dynamically visualize many data points across timelines and in other graphical interfaces.

According to another embodiment, the systems described herein include a telemedicine system for enabling anonymous distribution of medical images (“glimpses”) for diagnostic and other purposes. The receivers can archive data, view it in a 2D or 3D immersive display, and communicate with the user for a diagnosis and multiple opinions; the receivers including patients, providers and insurance carriers. For example, a health professional can receive and review the “glimpse” files (e.g., patients' X-rays) across a broad range of patients and potential patients without identifying the patient. The health professional can provide either a medical opinion or a recommendation of another health professional who is a better match to the patient.

According to another embodiment, an apparatus comprises at least one processor, and at least one memory including computer program code for one or more computer programs; =the at least one memory and the computer program code configured to, with at least one processor, cause, at least in part, the apparatus to generate a visual database for managing medical images, the toolsets for working with the visual database, and a telemedicine system for enabling anonymous distribution of medical images for diagnostic purposes.

According to another embodiment, a computer-readable storage medium carries one or more sequences of one or more instructions which, when executed by one or more processors, cause, at least in part, an apparatus to provide a visual database for managing medical images, the toolsets for working with the visual database, and a telemedicine system for enabling anonymous distribution of medical images for diagnostic purposes.

In addition, for various example embodiments of the invention, the following is applicable: a method comprising facilitating the processing of: (1) data and/or (2) information and/or (3) at least one signal. The data, information and/or at least one signal can be based, at least in part, on (or derived at least in part from) any one or any combination of methods (or processes) disclosed in this application as relevant to any embodiment of the invention.

For various example embodiments of the invention, the following is also applicable: a method for configuring at least one interface to allow access to at least one service, the at least one service being configured to perform any one or any combination of network or service provider methods (or processes) disclosed in this application.

For various example embodiments of the invention, the following is also applicable: a method for creating and/or modifying (1) at least one device user interface element and/or (2) at least one device user interface functionality. These devices may be based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side, on the mobile device side, or in any shared way between service provider and mobile device with actions being performed on both sides. The mobile device can be a wearable device such as Fitbit, Smartwatch, Google Glass and so on.

Still other aspects, features, and advantages of the invention are readily apparent from the following Detailed Description when illustrated by a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

These and other objects, features, and characteristics will become more apparent to those skilled in the art from a study of the following Detailed Description in conjunction with the appended claims and drawings, all of which form a part of this specification. While the accompanying drawings include illustrations of various embodiments, the drawings are not intended to limit the claimed subject matter.

FIGS. 1A-1B are diagrams of systems capable of providing a visual database for managing medical images, the toolsets for working with the visual database, and a telemedicine system for enabling anonymous distribution of medical images for diagnostic purposes, according to one embodiment;

FIGS. 2A-2C are flowcharts of a process for generating a visual database for managing medical images, according to one embodiment;

FIG. 3 is a flowchart of a process for generating the toolsets for working with the visual database, according to one embodiment;

FIG. 4 is a flowchart of a process for generating a telemedicine system for enabling anonymous distribution of medical images for diagnostic purposes, according to one embodiment;

FIG. 5 is a flowchart of a process for generating a telemedicine system for enabling anonymous distribution of medical images for diagnostic purposes, according to one embodiment;

FIG. 6 is a flow diagram of a process for generating a revision control system for enabling distribution of medical images for diagnostic purposes, according to one embodiment;

FIGS. 7-8 illustrate examples of a graphical user interface of the healthcare application of FIGS. 2A-2C for providing a visual database for managing medical images, according to one embodiment;

FIG. 9 illustrates an example of a graphical user interface of the healthcare application of FIG. 3 for providing the toolsets for working with the visual database, according to one embodiment;

FIGS. 10-20 illustrate examples of the graphical user interface of the healthcare application of FIGS. 2A-2C for providing a visual database for managing medical images, according to one embodiment; and

FIG. 21 is a diagram of a computing system that can be used to implement an embodiment of the invention.

### DETAILED DESCRIPTION OF SOME EMBODIMENTS

In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

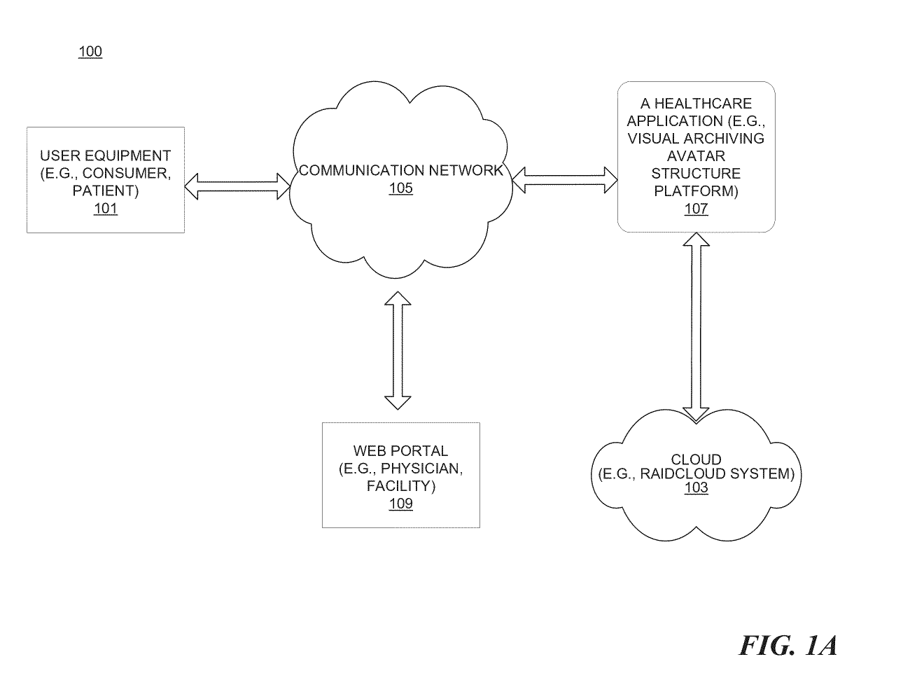

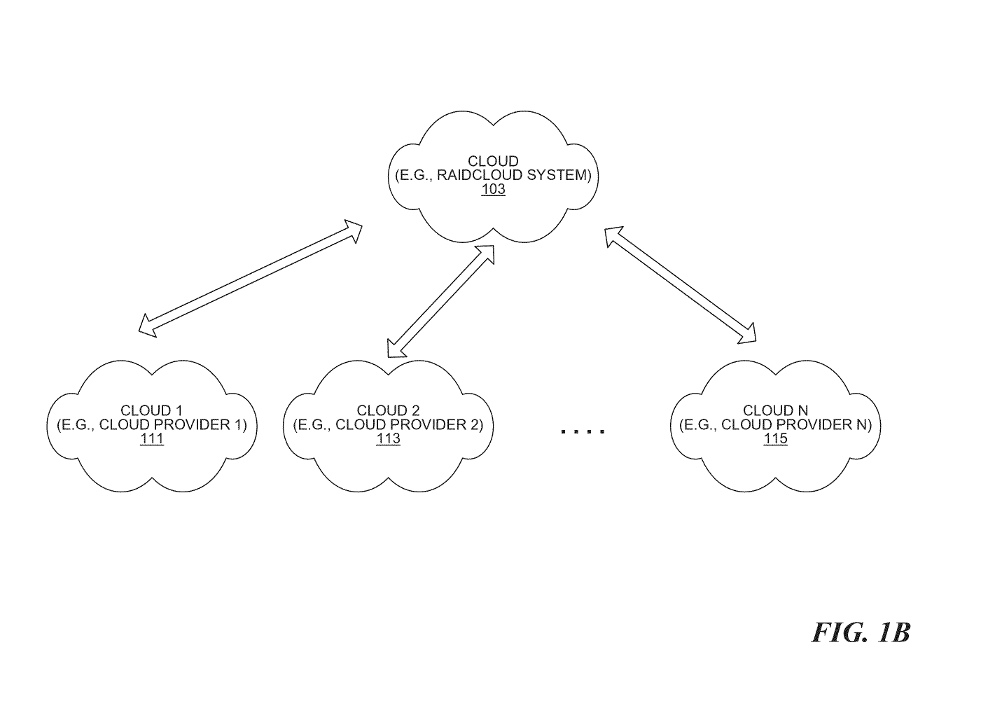

FIGS. 1A-1B are diagrams of a system 100 capable of providing a visual database for managing medical images, the toolsets for working with the visual database, and a telemedicine system for enabling anonymous distribution of medical images for diagnostic purposes, according to one embodiment. As shown in FIGS. 1A-1B, the system 100 can comprise a healthcare application (e.g., visual archiving avatar structure platform) 107, an enabled user equipment or UE (e.g., a smart device) 101 having connectivity to web portal (e.g., accessible by a physician, facility) 109 via the communication network 105 and the cloud network 103 (e.g., Raidcloud system having connectivity to other cloud providers 111, 113, 115, etc.). By way of example, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network (e.g., a proprietary cable or fiber-optic network, and the like, or any combination thereof). In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/camcorder, positioning device, television receiver, radio broadcast receiver, electronic book device, game device, the accessories and peripherals of these devices, or any combination thereof. It is also contemplated that the UE 101 can support any type of input interface to the user (such as “wearable” circuitry, etc.)

By way of example, the UE 101, the cloud 103, a healthcare application (visual archiving avatar structure platform) 107 and the web portal 109 communicate with each other and other components of the communication network 105 using well known, new, or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

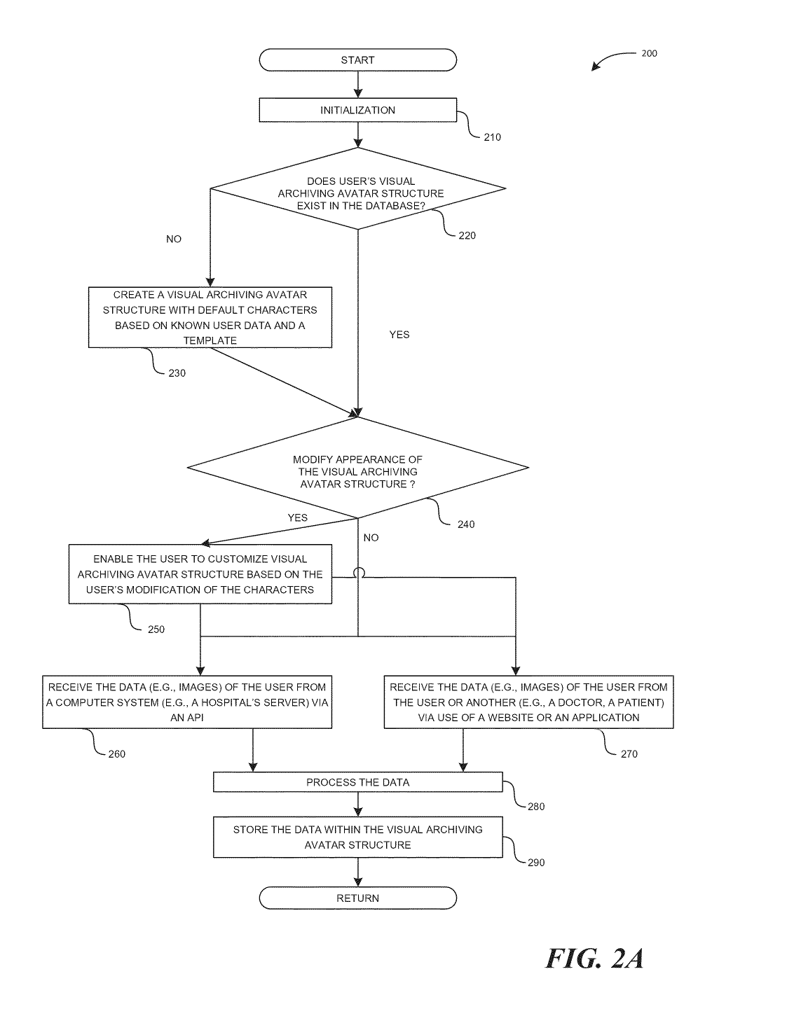

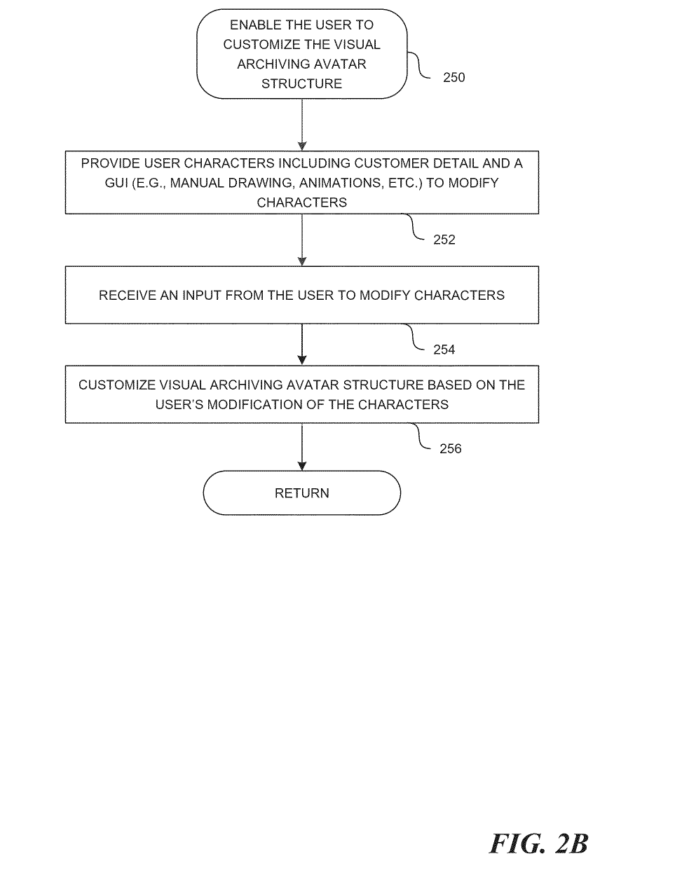

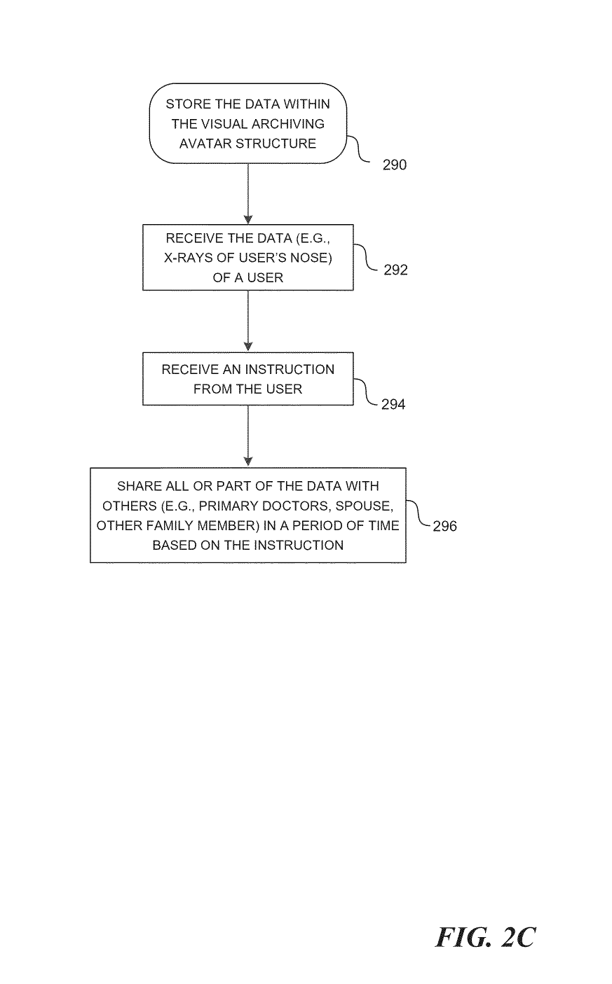

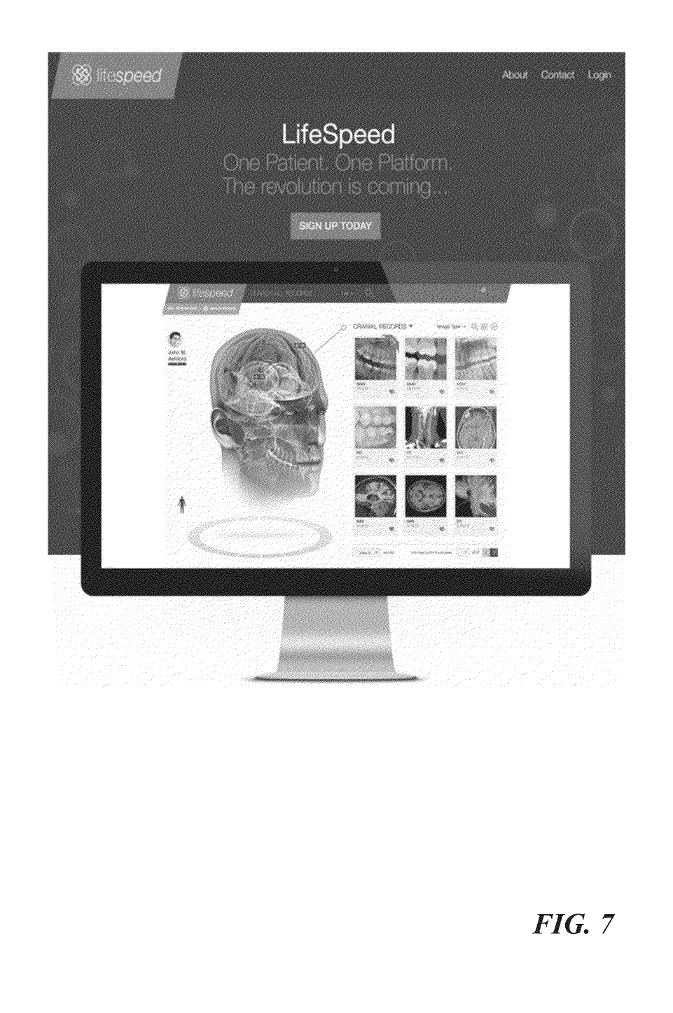

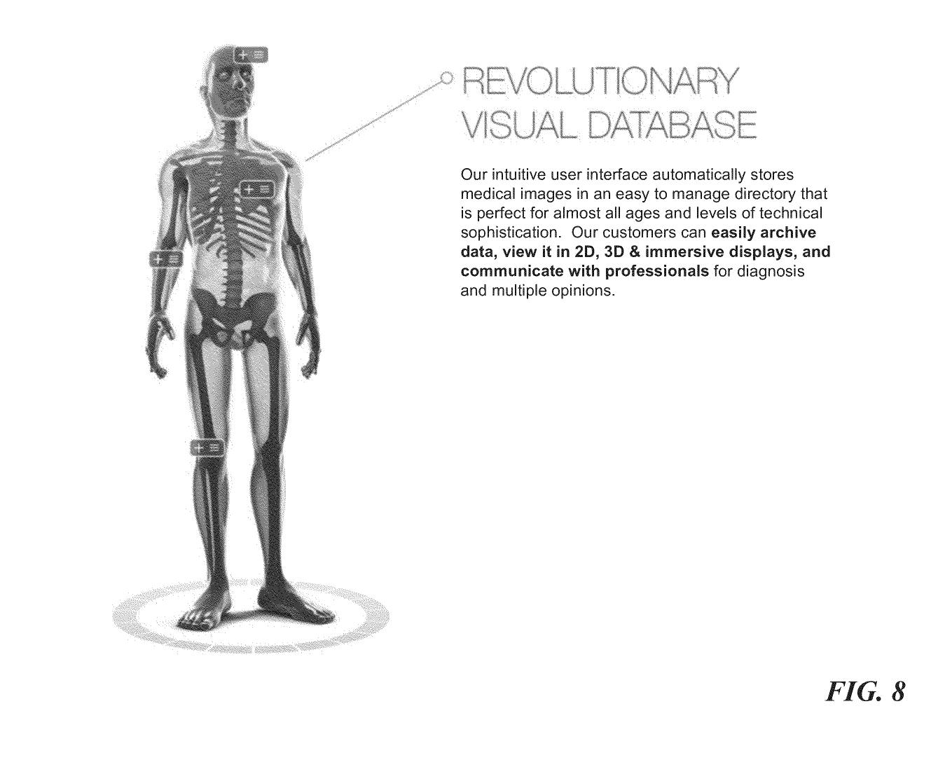

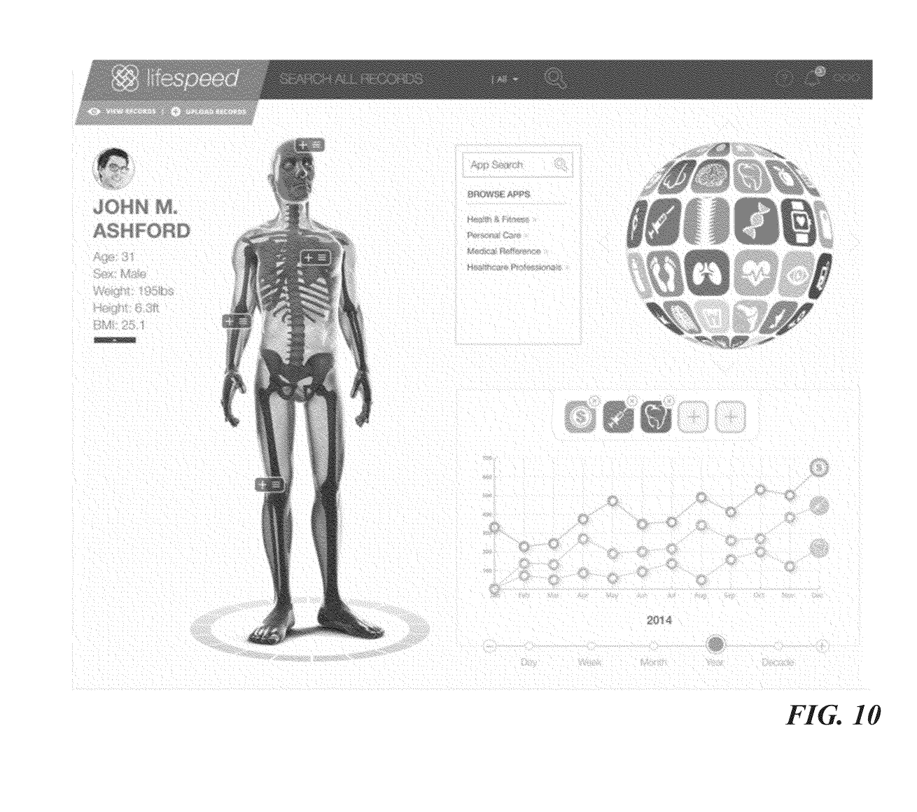

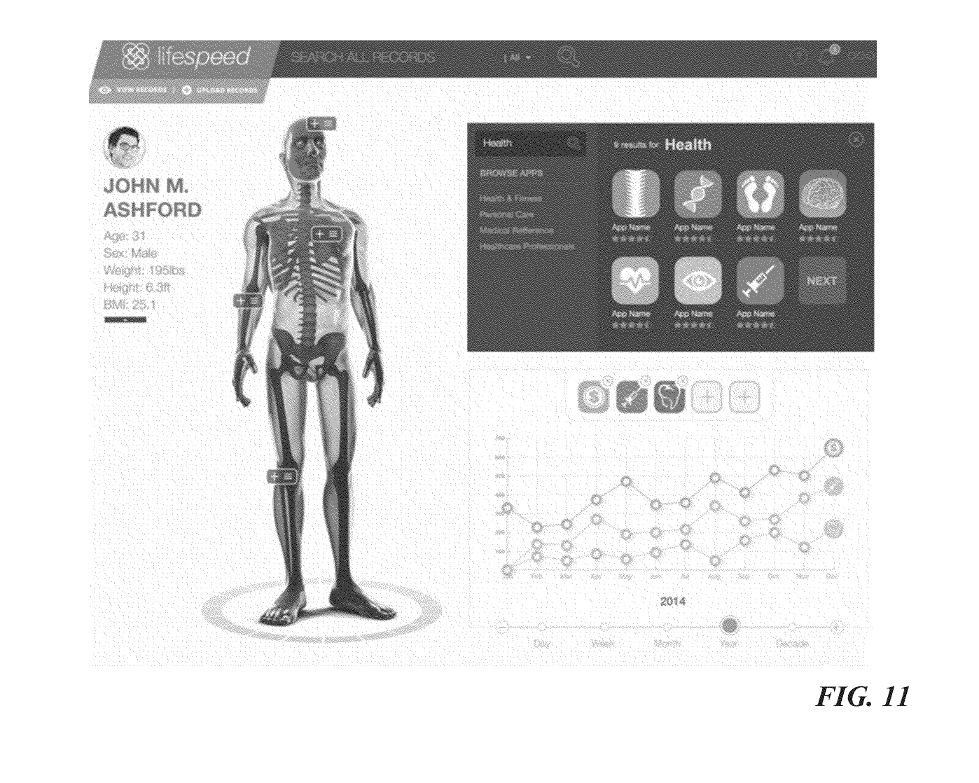

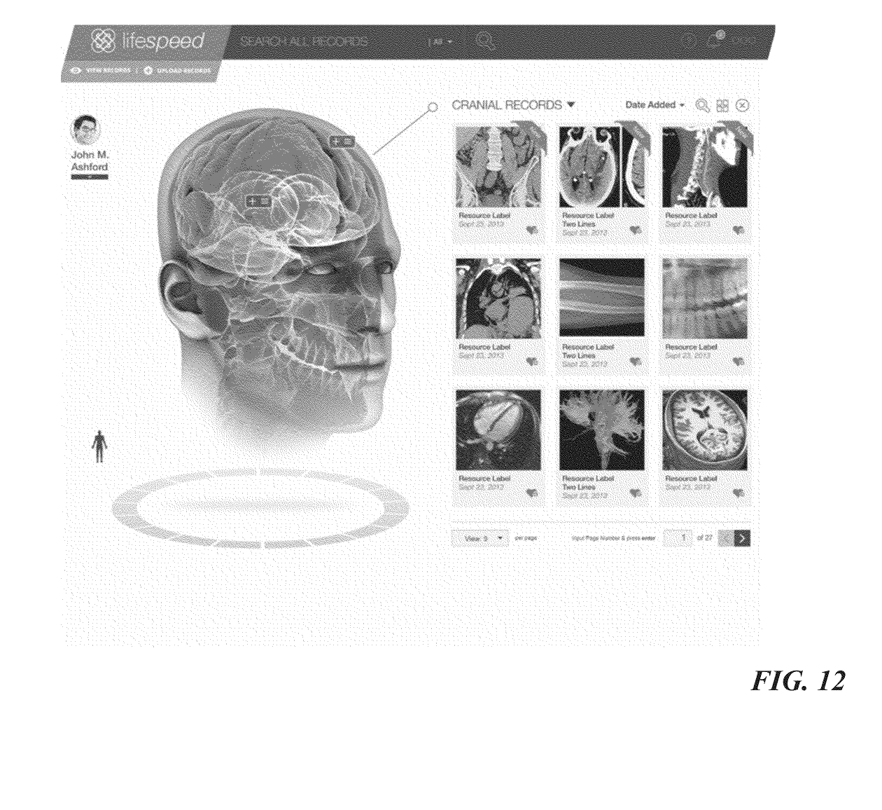

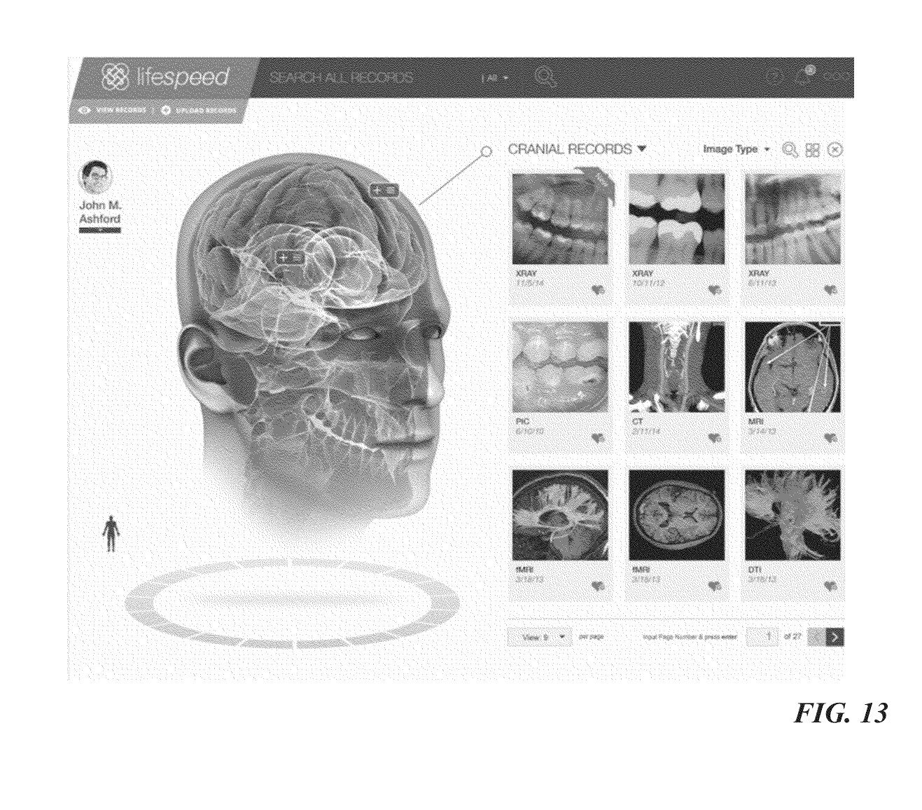

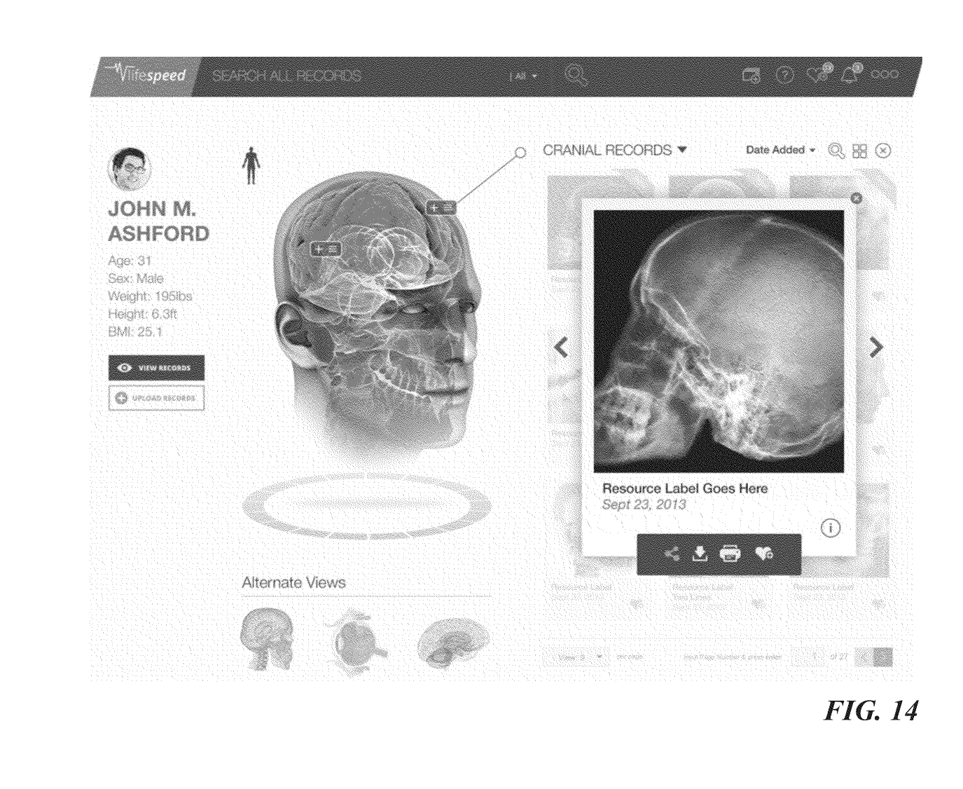

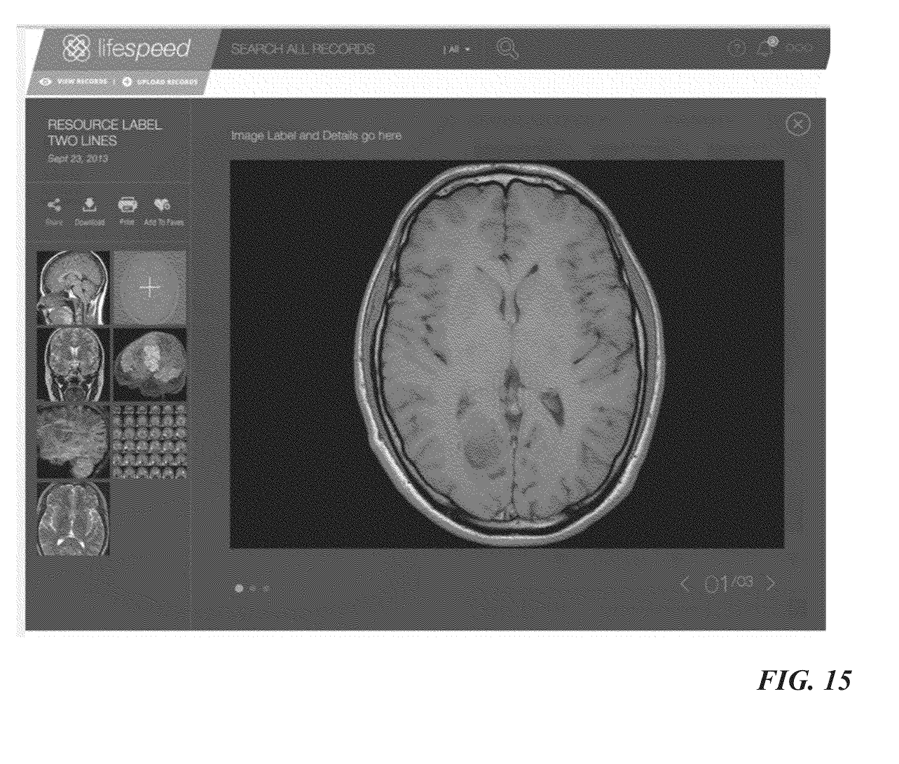

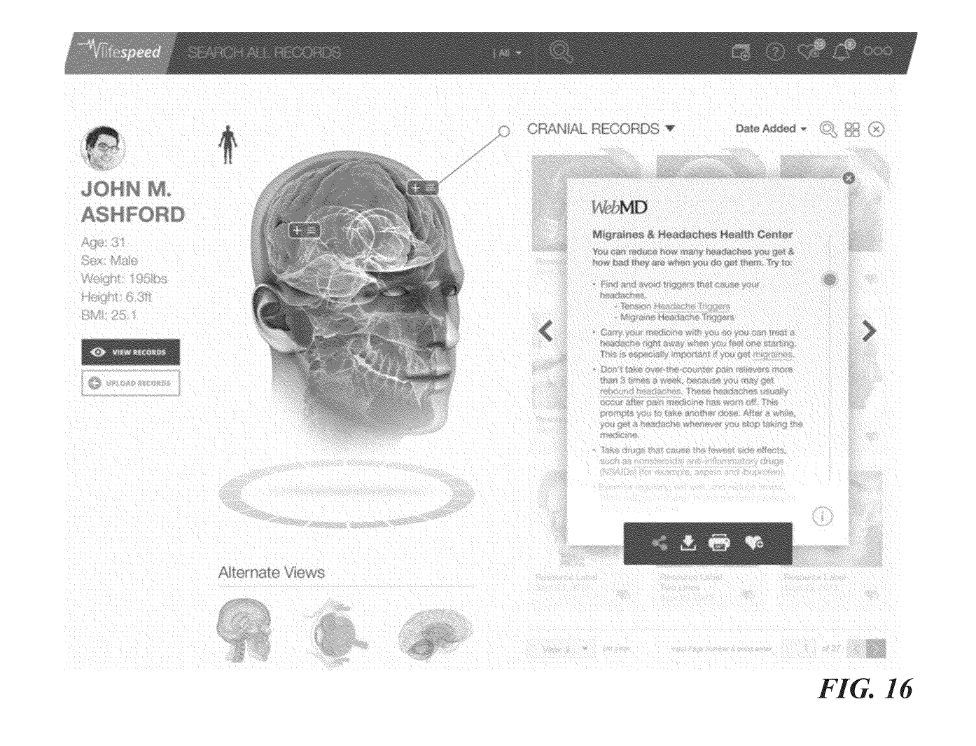

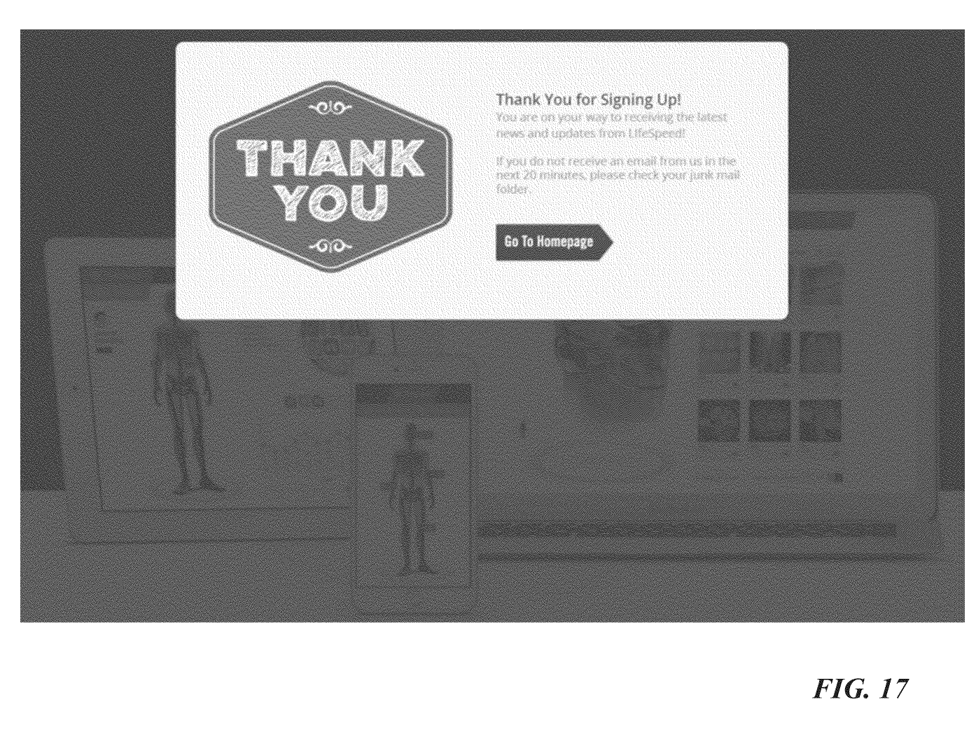

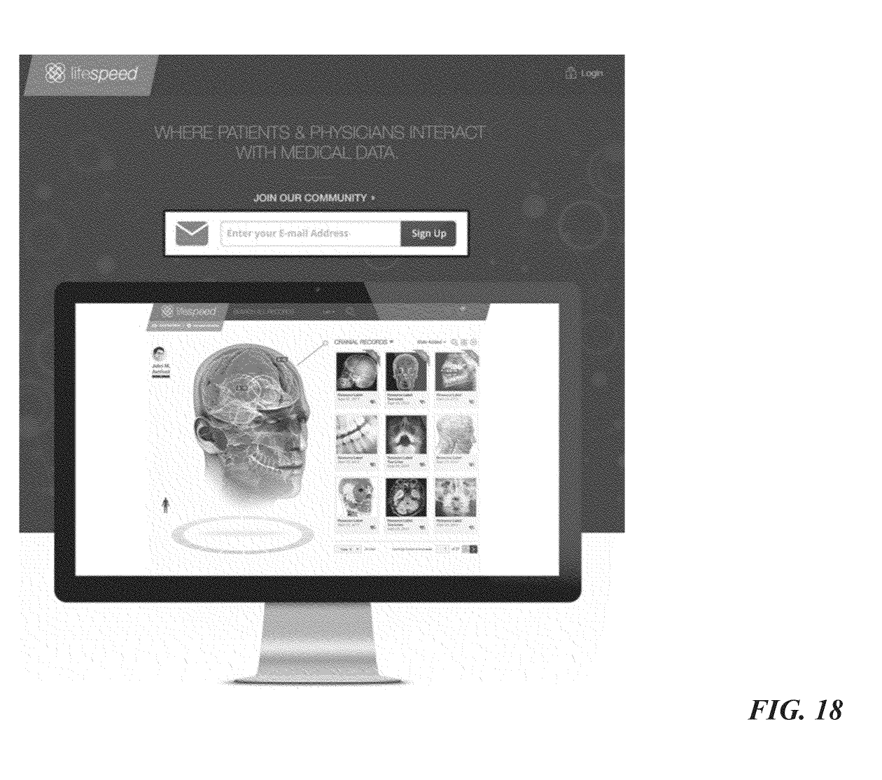

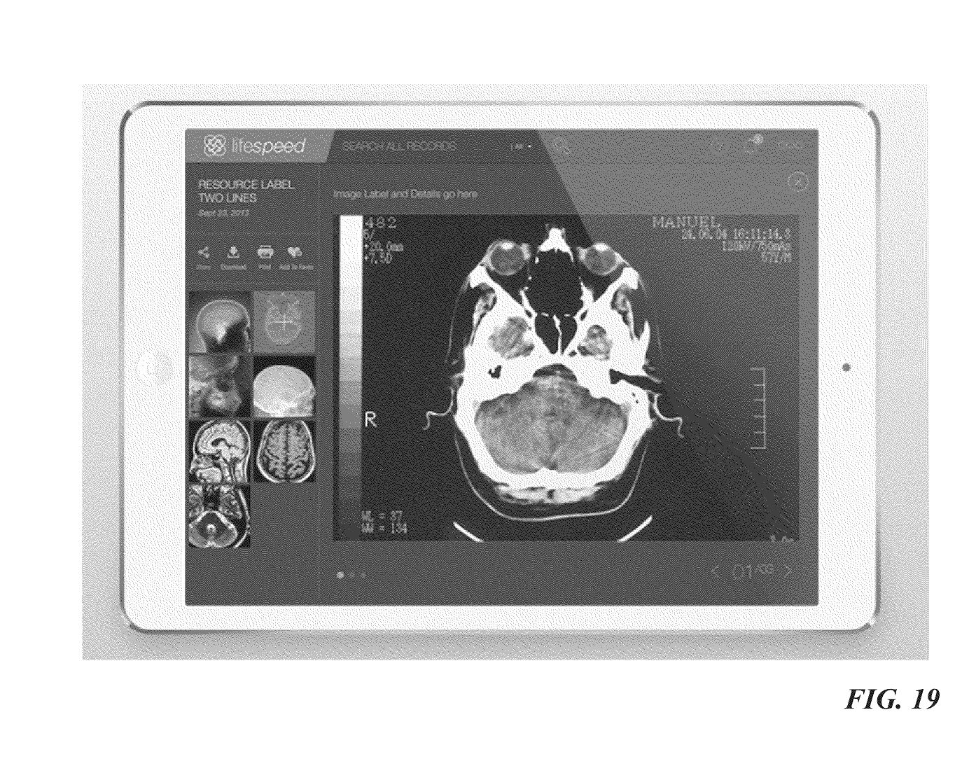

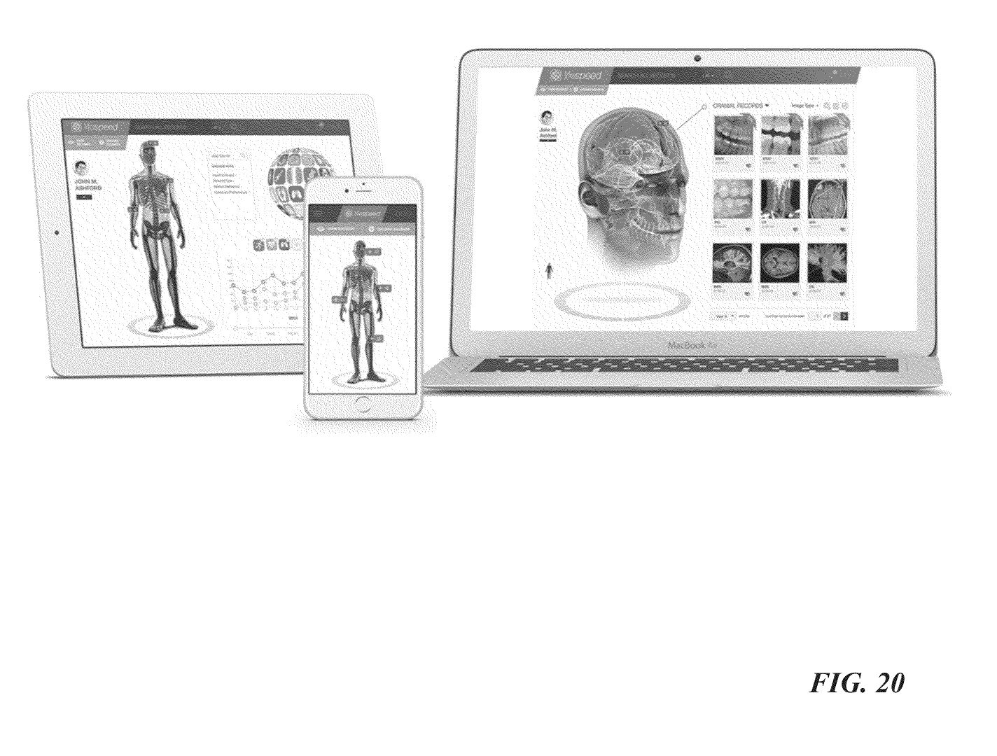

FIGS. 2A-2C are flowcharts of a process 200 for generating a visual database for managing medical images, according to one embodiment. In steps 210, 220 and 230, a visual archiving avatar structure platform 107 may obtain data to create a visual archiving avatar structure with default characters based on known user data and a template. In steps 240, 250, 252, 254 and 256, a visual archiving avatar structure platform 107 may enable the user to customize the visual archiving avatar structure. In steps 260, 270, 280, and 290, the system may receive the data (e.g., digital media, audio, image) of the user from a computer system (e.g., a hospital's server) via an API and/or receive the data (e.g., images) of the user from the user or another (e.g., a doctor, a patient) via use of a website or an application, process the data, and store the data within the visual archiving avatar structure. In steps 290, 292, 294, and 296, the system may enable the user to share all or part of the data with others (e.g., primary doctors, spouse, other family member) within a period of time based on the user's instruction. By way of example, the user may share the data with a group of people in the user's circle of trust in a period of time (e.g., primary doctor). The data can include the medical image of the user and other related information, and/or share the data with a group of people in the user's circle of trust in a period of time (e.g., family member). In some embodiments, the data includes the medical image only. In some embodiments, the system can generate an access record for the user. According to one embodiment, the structure of the directory and image database is based on a skeletal model similar to that used in modern animation, and the directory is provided in a sophisticated GUI as a navigable human avatar. In some embodiments, the avatar can be skeletal, based on an image of a user, or can be customized. The user can archive data and view the data in a two-dimensional (2D) or three-dimensional (3D) immersive display. FIGS. 7-8 and 10-20 illustrate examples of the graphical user interface of the healthcare application of FIGS. 2A-2C for providing a visual database for managing medical images.

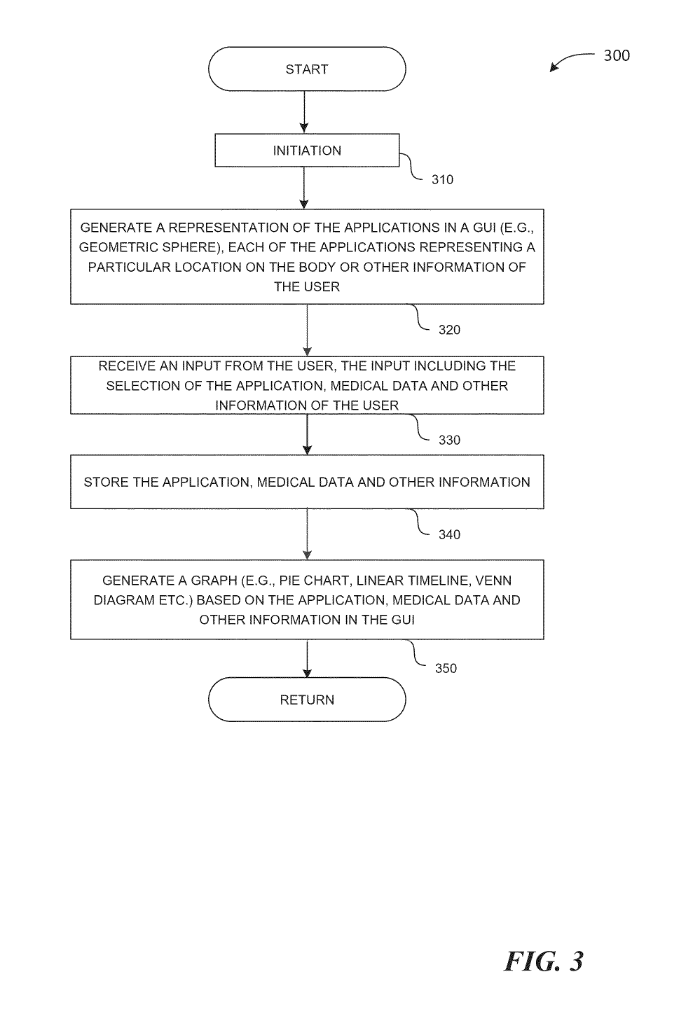

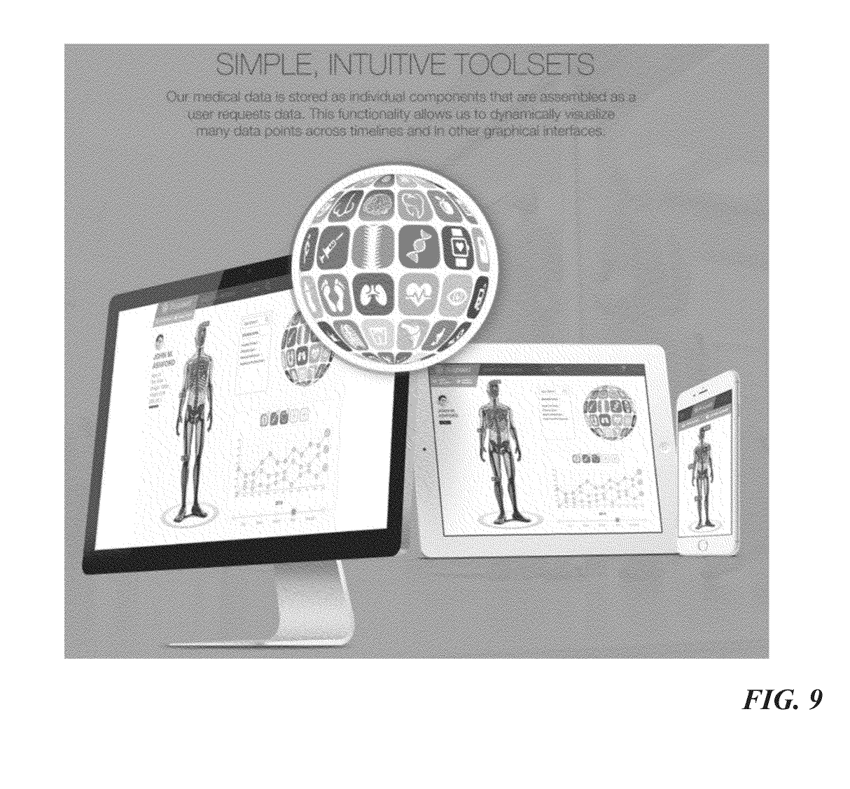

FIG. 3 is a flowchart of a process 300 for generating the toolsets for working with the visual database, according to one embodiment. In steps 310 and 320, the system may generate a representation of the applications in a graphical user interface or GUI (e.g., Geometric Sphere), wherein each of the applications represents a particular location on the body or other information of the user. In step 330, the system may receive an input from the user, the input including the selection of the application, medical data and other information of the user. In steps 340 and 350, the system may store the application, medical data and other information, and generate a graph (e.g., pie chart, linear timeline, Venn Diagram, etc.) based on the application, medical data and other information in the GUI. FIG. 9 illustrates an example of a graphical user interface of the healthcare application of FIG. 3 for providing the toolsets for working with the visual database, according to one embodiment.

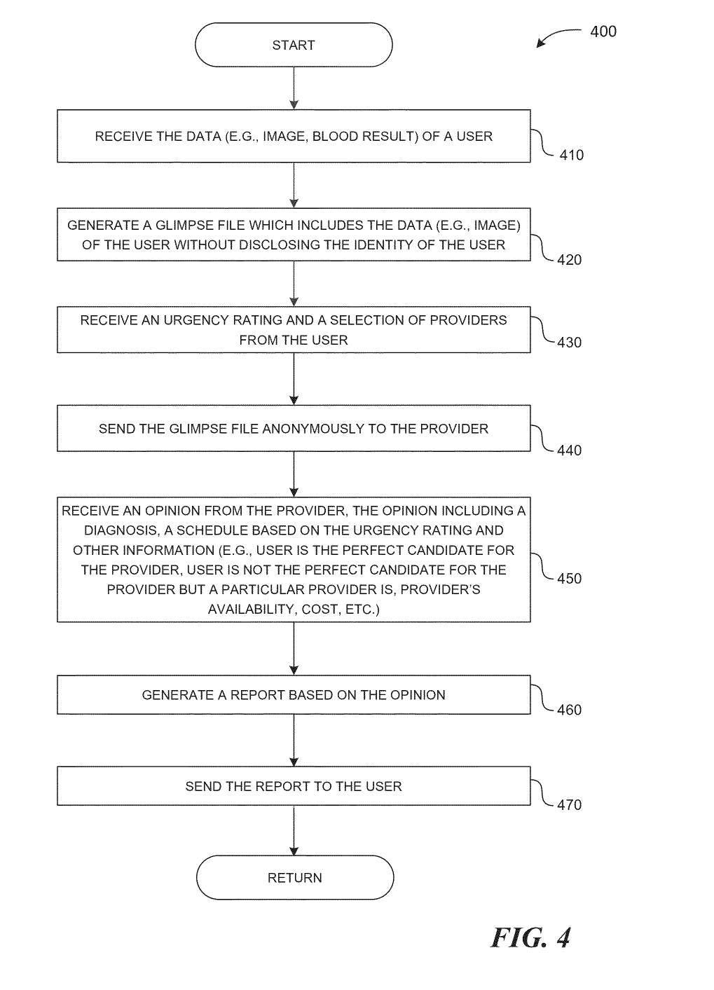

FIG. 4 is a flowchart of a process 400 for generating a telemedicine system for enabling anonymous distribution of medical images for diagnostic purposes, according to one embodiment. In step 410, the system may receive the data (e.g., image, blood result) of a user. In step 420, the system may generate a glimpse file that includes the data (e.g., image) of the user without disclosing the identity of the user. In steps 430 and 440, the system may receive an urgency rating and a selection of providers from the user, and send the glimpse file anonymously to the provider. In step 450, the system may receive an opinion from the provider. The opinion may include a diagnosis, a schedule based on the urgency rating and/or other information (e.g., user is the perfect candidate for the provider, user is not the perfect candidate for the provider but is for another provider, provider's availability, cost, etc.). In steps 460 and 470, the system may generate a report based on the opinion and send the report to the user.

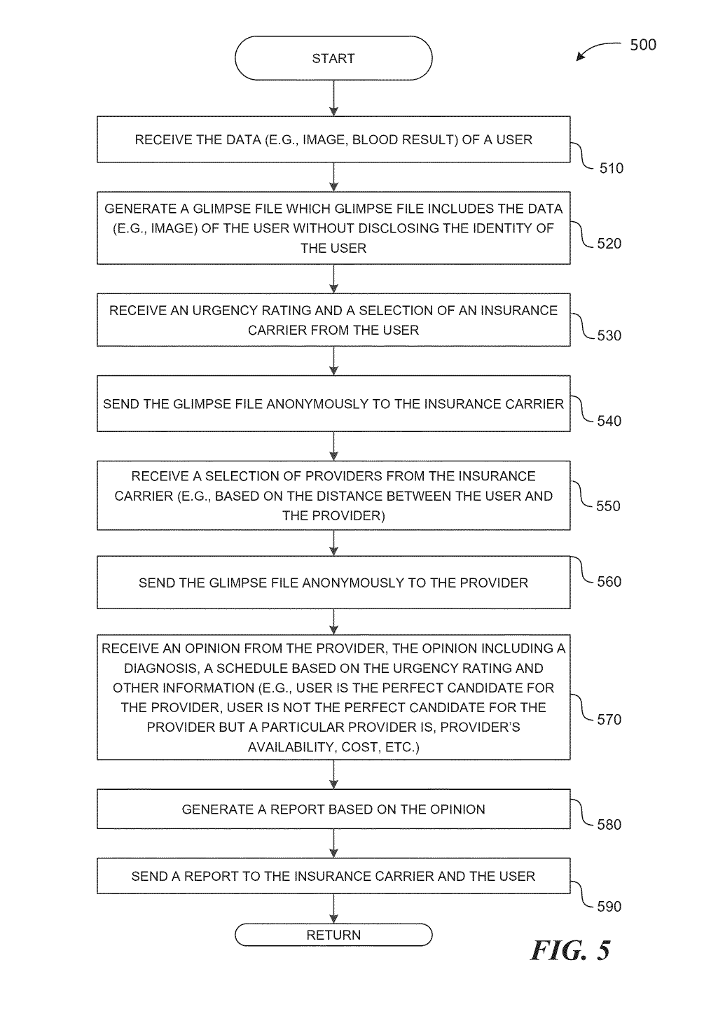

FIG. 5 is a flowchart of a process 500 for generating a telemedicine system for enabling anonymous distribution of medical images for diagnostic purposes, according to one embodiment. In step 510, the system may receive the data (e.g., image, blood result) of a user. In step 520, the system may generate a glimpse file that includes the data (e.g., image) of the user without disclosing the identity of the user. In steps 530 and 540, the system may receive an urgency rating and a selection of insurance carrier from the user, and send the glimpse file anonymously to the insurance carrier. In steps 550 and 560, the system may receive a selection of providers from the insurance carrier (e.g., based on the distance between the user and the provider) and send the glimpse file anonymously to the provider. In step 570, the system may receive an opinion from the provider. The opinion may include a diagnosis, a schedule based on the urgency rating and/or other information (e.g., user is the perfect candidate for the provider, user is not the perfect candidate for the provider but is for another provider, provider's availability, cost, etc.). In steps 580 and 590, the system may generate a report based on the opinion and send the report to the insurance carrier and the user.

According to one embodiment, the receivers (e.g., a person or an entity) can archive data, view it in a 2D or 3D immersive display, and communicate with the user for diagnosis and multiple opinions; the receivers including patients, providers and insurance carriers. A health professional may receive and review the “glimpse” files (e.g., patients' X-rays) across a broad range of patients and potential patients without accessing patients' identities. The health professional can then provide either a medical opinion or the recommendations of other health professionals who are the better match to the patients. Medical professionals may need to display all dental records for the previous 18 months of a given family. The user would drag patients' names onto a timeline and adjust the “in” and “out” points of the timeline to display all the events those patients were involved in during this time. As another example, if the user wishes to see weight loss correlated to fitness metrics, the user may drag a fitness icon onto a timeline, and then drag a bodyweight icon onto the timeline. Statistics and graphs can be automatically generated for a user's visualization needs.

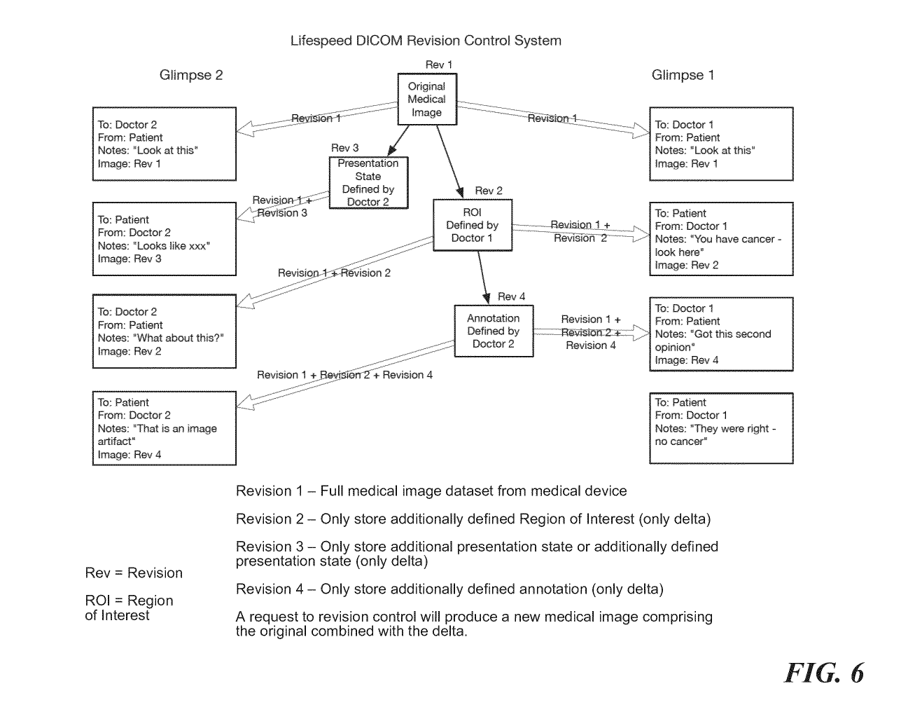

FIG. 6 illustrates enabling flow diagram for anonymous distribution of medical images for diagnostic purposes, according to one embodiment. Medical Image Revision Control System (MIRCS) is designed to archive multiple versions of a medical image while storing minimal data. MIRCS achieves this by storing only differences in each version, the differences can also be referred to as deltas, while maintaining a dependency graph structure. Each delta is stored with a revision number and has a dependency on an existing revision number. In some embodiments, a specific version of a medical image can be reconstructed by traversing the dependency graph and merging the datasets. In this way, a medical image can be queried from MIRCS using a revision number as a starting point.

By way of example, a glimpse file may store a MIRCS revision number when storing a reference to a medical image. MIRCS uses that revision number to reconstruct and deliver a medical image that is identical to the medical image that was archived.

FIGS. 7-20 illustrate examples of the graphical user interface of the healthcare application of FIGS. 2A-2C for providing a visual database for managing medical images, according to one embodiment.

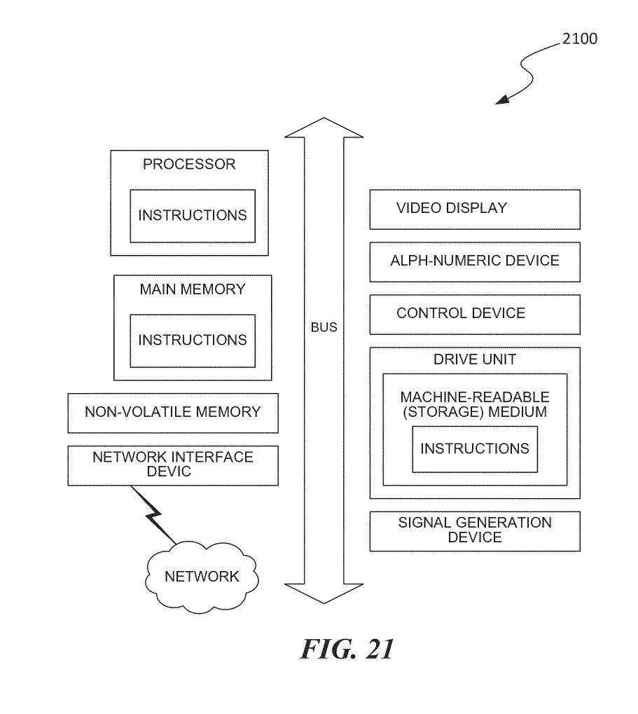

Referring now to FIG. 21, therein is shown a diagram representing a machine in the example form of a computer system 2100 within which a set of instructions may be executed that cause the machine to perform any one or more of the methodologies or modules discussed herein.

In the example of FIG. 21, the computer system 2100 includes a processor, memory, non-volatile memory, and a network interface device. Various common components (e.g., cache memory) are omitted for illustrative simplicity. The computer system 2100 is intended to illustrate a hardware device on which any of the components described in the example of FIGS. 1-6 (and any other components described in this specification) can be implemented. The computer system 2100 can be of any applicable known or convenient type. The components of the computer system 2100 can be coupled together via a bus or through some other known or convenient device.

This disclosure contemplates the computer system 2100 taking any suitable physical form. As an example and not by way of limitation, computer system 2100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 2100 may include one or more computer systems 2100; be unitary or distributed; span multiple locations; span multiple machines; or reside in a cloud, which may include one or more cloud components in one or more networks. Where appropriate, one or more computer systems 2100 may perform, without substantial spatial or temporal limitation, one or more steps of one or more methods described or illustrated herein. As an example and not by way of limitation, one or more computer systems 2100 may perform, in real time or in batch mode, one or more steps of one or more methods described or illustrated herein. One or more computer systems 2100 may perform, at different times or at different locations, one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk; a magnetic-optical disk; an optical disk; a read-only memory (ROM), such as a CD-ROM, EPROM, or EEPROM; a magnetic or optical card; or another form of storage for large amounts of data. Some of this data is often written, by a direct memory access process, into memory during execution of software in the computer system 2100. The non-volatile memory can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this application. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The network interface device can include one or more of a modem or network interface. It will be appreciated that a modem or network interface device can be considered to be part of the computer system 2100. The network interface device can include an analog modem, isdn modem, cable modem, token ring interface, satellite transmission interface (e.g., “direct PC”), or other interfaces for coupling a computer system to other computer systems. The network interface device can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 21 reside in the network interface device.

In operation, the computer system 2100 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files in the non-volatile memory and/or drive unit.

Some portions of the Detailed Description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, both here and in general, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the terms “machine-readable medium” and “machine-readable storage medium” should be taken to include a single medium or multiple media (e.g., a centralized or distributed database, and/or associated caches and servers) that store the one or more sets of instructions. The terms “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media (such as volatile and non-volatile memory devices), floppy and other removable disks, hard disk drives, optical disks (e.g., Compact Disk Read-Only Memory (CD ROMS), Digital Versatile Disks, (DVDs), etc.), among others, and transmission type media (such as digital and analog communication links).

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state from a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, “non-transitory” refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Unless the context clearly requires otherwise, throughout the Detailed Description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

While processes or blocks are presented in a given order, alternative embodiments may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in their implementation, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, 916, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this Detailed Description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combination thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple-processor designs for increased computing capability.

Embodiments of the invention may also relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for customizing a visual archiving avatar structure, the method comprising:
providing a plurality of character options for the visual archiving avatar structure of a user, the visual archiving avatar structure presented to the user via a graphical user interface, wherein the visual archiving avatar structure includes a drawing input by the user or an image of the user, and wherein the plurality of character options includes an animation or an overlay for the drawing or the image;
receiving an input from the user, the input including a selection of one of the plurality of character options; and
generating a customized visual archiving avatar structure of the user based on the input.

2. A method for generating a visual database for managing medical images, the method comprising:
receiving a set of data associated with a user, the set of data including an image and a remark, the remark generated by a healthcare professional;
receiving an instruction from the user, the instruction including a configuration that permits a second user to access at least a portion of the set of data, and an identification of a time period during which the second user is permitted to access the portion of the set of data; and
permitting the second user to access the portion of the set of data based on the instruction.

3. A method for generating a representation of executable applications in a geometric sphere interface, the method comprising:
receiving an input from a user; wherein the input includes one or more of:
an application,
medical data, and
a health record;
storing the input from the user; and
generating a graph based on the input from the user.

4. A method for generating a telemedicine system for enabling anonymous distribution of medical images, the method comprising:
receiving a first set of data associated with a user;
generating a glimpse file, the glimpse file including the first set of data associated with the user without disclosing the identity of the user;
receiving an urgency rating and a selection of providers from the user;
sending the glimpse file anonymously to the providers;
receiving an opinion from at least one provider, the opinion including a diagnosis, a schedule based on the urgency rating and other information;
generating a report based on the opinion; and
sending the report to the user.

5. A method for generating a telemedicine system for enabling anonymous distribution of medical images, the method comprising:
receiving a first set of data associated with a user;
generating a glimpse file, the glimpse file including the first set of data associated with the user without disclosing the identity of the user;
receiving an urgency rating and a selection of an insurance carrier from the user;
sending the glimpse file anonymously to the insurance carrier;
receiving a selection of providers from the insurance carrier;
sending the glimpse file anonymously to the providers;
receiving an opinion from at least one provider, the opinion including a diagnosis, a schedule based on the urgency rating and other information;
generating a report based on the opinion; and
sending the report to the insurance carrier and the user.

6. The method recited above in claim 5, wherein the selection of providers is based on the distance between the user and the providers.

7. An apparatus comprising:
at least one processor; and
at least one memory including computer program code for one or more programs,
the at least one memory and the computer program code configured to, with the at least one processor, cause the apparatus to perform at least the following,
providing a plurality of character options for a visual archiving avatar structure of a user, the visual archiving avatar structure presented to the user via a graphical user interface, wherein the visual archiving avatar structure includes a drawing input by the user or an image of the user, and wherein the plurality of character options includes an animation or an overlay for the drawing or the image;
receiving an input from the user, the input including a selection of one of the plurality of character options; and
generating a customized visual archiving avatar structure of the user based on the input.

8. An apparatus comprising:
at least one processor; and
at least one memory including computer program code for one or more programs,
the at least one memory and the computer program code configured to, with the at least one processor, cause the apparatus to perform at least the following,
receiving a set of data associated with a user, the set of data including an image and a remark, the remark generated by a healthcare professional;
receiving an instruction from the user, the instruction including a configuration that permits a second user to access at least a portion of the set of data, and an identification of a time period during which the second user is permitted to access the portion of the set of data; and
permitting the second user to access the portion of the set of data based on the instruction.

9. An apparatus comprising:
at least one processor; and
at least one memory including computer program code for one or more programs,
the at least one memory and the computer program code configured to, with the at least one processor, cause the apparatus to perform at least the following,
receiving an input from a user; wherein the input includes one or more of:
an application;
medical data; and
a health record;
storing the input from the user; and
generating a graph based on the input from the user.

10. An apparatus comprising:
at least one processor; and
at least one memory including computer program code for one or more programs,
the at least one memory and the computer program code configured to, with the at least one processor, cause the apparatus to perform at least the following,
receiving a first set of data associated with a user;
generating a glimpse file, the glimpse file including the first set of data associated with the user without disclosing the identity of the user;
receiving an urgency rating and a selection of providers from the user;
sending the glimpse file anonymously to the providers;
receiving an opinion from at least one provider, the opinion including a diagnosis, a schedule based on the urgency rating and other information;
generating a report based on the opinion; and
sending the report to the user.

11. An apparatus comprising:
at least one processor; and
at least one memory including computer program code for one or more programs,
the at least one memory and the computer program code configured to, with the at least one processor, cause the apparatus to perform at least the following,
receiving a first set of data associated with a user;
generating a glimpse file, the glimpse file including the first set of data associated with the user without disclosing the identity of the user;
receiving an urgency rating and a selection of an insurance carrier from the user;
sending the glimpse file anonymously to the insurance carrier;
receiving a selection of providers from the insurance carrier;
sending the glimpse file anonymously to the providers;
receiving an opinion from at least one provider, the opinion including a diagnosis, a schedule based on the urgency rating and other information;
generating a report based on the opinion; and
sending the report to the insurance carrier and the user.

12. The apparatus of claim 11, wherein the selection of providers is based on the distance between the user and the providers.
